(19) United States
(12) Patent Application Publication
(10) Pub. No.: US 2018/0295808 A1
(43) Pub. Date: Oct. 18, 2018

(54) INTELLIGENT WATER DISPENSING SYSTEM FOR PETS

(71) Applicant: THIRSTYPET LLC, Tucson, AZ (US)

(72) Inventors: Christopher NERO, Tucson, AZ (US); Stephen M. BAQUET, Tucson, AZ (US)

(21) Appl. No.: 15/952,486

(22) Filed: Apr. 13, 2018

Related U.S. Application Data
(60) Provisional application No. 62/485,245, filed on Apr. 13, 2017.

(51) Int. Cl. A01K 7/02; A01K 13/00

(52) U.S. Cl. CPC A01K 7/025; A01K 13/003

(57) ABSTRACT

A system and method relates to providing water to and for animals. More specifically, the present invention relates to an automated method and system for providing water and nutritional supplements to and for animals without burdensome attendance or intervention by the system user. A system and method of providing water and/or nutritional supplements to an animal, sub-group, or group of animals under electrical, electronic, or “smart-device” control.

### CROSS REFERENCE TO RELATED APPLICATION

This application claims priority to U.S. Provisional Patent Application No. 62/485,245 filed on Apr. 13, 2017. The contents of this application are incorporated by referenced into this application in their entirety.

### FIELD OF THE INVENTION

The present inventive system and method relates to providing water to and for animals. More specifically, the present invention relates to an automated system and method for providing water and nutritional supplements to and for animals without burdensome attendance or intervention by the system user.

### BACKGROUND OF THE INVENTION

There is little need to discuss at length the necessity of providing adequate water to and for domesticated and/or captive animals and livestock. Without a clean and plentiful supply of water, animals as well as humans will quickly become seriously dehydrated which can and does negatively impact overall health and well-being. Contaminated water supplies cause illness, disease, suffering, and death worldwide; in both human and animal populations. For most living creatures on this Earth, without water—life ends.

Many methods and systems are known to provide water to animals; simple pet bowls or basins, inverted bottle reservoirs with spring loaded ball-valves, livestock troths with pressurized water supplies and float-valves, and the like.

Some known systems include U.S. Pat. No. 3,991,719 to Bruce; U.S. Pat. No. 4,782,790 to Batson; U.S. Pat. No. 5,377,852 to Demorest; U.S. Pat. No. 5,433,171 to Ewell; U.S. Pat. No. 5,445,110 to Birnie; U.S. Pat. No. 5,709,168 to Walker; U.S. Pat. No. 5,967,181 to Momont et al.; U.S. Pat. No. 6,098,959 to Momont et al.; U.S. Pat. No. 6,164,311 to Momont et al.; U.S. Pat. No. 6,367,417 to Gal et al.; U.S. Pat. No. 7,204,202 to Behun et al.; U.S. Pat. No. 7,314,023 to Denny et al.; U.S. Pat. No. 7,380,518 to Kates; U.S. Pat. No. 7,392,761 to Kujawa et al.; U.S. Pat. No. 7,409,924 to Kates; U.S. Pat. No. 7,441,514 to Dana et al.; U.S. Pat. No. 7,634,975 to Kates; U.S. Pat. No. 7,861,676 to Kates; U.S. Pat. No. 8,056,510 to Handley et al.; U.S. Pat. No. 8,146,535 to Neumann; US U.S. Pat. No. 8,544,418 to Jiang et al.; US2006/0011144 to Kates; US2006/0201433 to Kates; US2006/0201436 to Kates; US2008/0035067 to Ogden; US2008/0223300 to Kates; US2011/0283946 to Fairbanks; US2014/0352621 to Fairbanks; US2015/0250138 to McKinnon et al.; and US2016/0212970 to McKinnon et al.

However, all known systems are deficient related to suppling water to an animal without active or semi-active human interaction or supervision.

Most known systems allow water to remain in a bowl or basin even when not required nor being actively consumed by an animal. This allows the water to stagnate in high humidity environments; and conversely, to continually evaporate and be replaced—which is wasteful—especially under severe low humidity and drought conditions.

Moreover, by allowing water to remain and be constantly replaced in a bowl or basin, any and all animals which approach may consume the water; thus tracking how much water is being consumed overall, and/or how much water a particular animal is consuming over time is impossible.

Generally, water is supplied unrestrictedly to and as desired by an individual animal or group of animals. However, in certain circumstances water intake by an animal may need to be restricted or halted; such as prior to or after veterinary surgery, or with animals or groups of animals used in scientific and/or medical research. All known systems are not designed for, nor intended to, regulate the supply of water nor track or restrict the intake of water by an animal or group of animals.

What is desired therefore is system and method to solve these problems and to provide water to an individual animal or group of animals.

### SUMMARY OF THE INVENTION

It is therefore an object of the present invention to provide a method and system to provide a supply of water to an animal with little or no human supervision, attendance, or intervention.

It is another object of the present invention to provide a method and system to provide a supply of water to an animal or group of animals which prevents the water from collecting and stagnating in a bowl or basin.

It is another object of the present invention to provide a method and system which includes removable and/or replaceable liners which prevent the accumulation of calcium and other minerals from collecting in and adhering to the bowl or basin.

It is another object of the present invention to provide a method and system to provide a supply of water to an animal or group of animals which prevents the water from evaporating and be continually re-supplied in a bowl or basin.

It is another object of the present invention to provide a method and system to provide a supply of water to an animal which detects the presence of an animal before providing a supply of water to the detected animal.

It is another object of the present invention to provide a supply of water to an animal which detects and differentiates one animal from another and provides a specific and differing supply of water to each animal according to the detection and differentiation criteria.

It is another object of the present invention to provide a supply of water to an animal based at least in part upon the animal species, breed, medical condition, environment, and/or other conditions, parameters, and the like.

It is another object of the present invention to provide a supply of water to an animal which includes nutritional supplements being added to the water.

It is another object of the present invention to provide a supply of water to an animal which detects and differentiates one animal from another and provides a specific and differing type and/or amount of nutritional supplements to the supply of water according to the animal detection and differentiation criteria.

It is another object of the present invention to provide a supply of water to an animal, a sub-group, or group of animals which tracks the amount of water supplied and consumed.

It is another object of the present invention to provide method and system which includes at least one sensor which via a controller can detect and/or differentiate when an animal, sub-group, or group of animals is seeking, desires, and/ or should be allowed to be supplied with water.

It is another object of the present invention to provide method and system which includes at least one sensor which via a controller can detect the presence and/or amount of water in or supplied to a bowl or basin, and enable or actuate a selected amount of water be supplied to a bowl or basin based at least in part on the detected water amount or level.

These and other objects of the invention are achieved by providing an apparatus for providing water to an animal in selected amounts at predetermined intervals without human attendance, comprising: a basin; a conduit including at least one valve, the conduit in fluid communication with the water supply and the basin; a sensor in communication with a controller; and wherein the controller via the sensor actuates the at least one value to maintain a selected level or amount of water in the basin.

In certain embodiments, the controller is capable of interfacing with a wired or wireless communication network.

In certain embodiments, the communication network is connected to and interfaces with the internet.

In certain embodiments, the supply of water is self-contained and provided to the basin via the conduit and at least one valve by gravity.

In certain embodiments, the supply of water is under pressure at the input of the at least one valve.

In certain embodiments, the conduit or at least one valve includes a filter.

In certain embodiments, the water supply includes a nutritional supplement.

In certain embodiments, the controller via the at least one value regulates the amount of the nutritional supplement included in the water supply.

In certain embodiments, the apparatus further includes a nutritional supplement supply, the nutritional supplement supply in fluid communication with the water supply via a second conduit and second valve; whereby the controller via the second valve regulates the amount of the nutritional supplement added to the water supply.

In certain embodiments, the controller via communication with the internet provides water supply use and/or nutritional supplement use information and parameters to apparatus user.

In certain embodiments, the apparatus further includes an application program for remotely selecting amount and intervals of water supplied to the animal.

In certain embodiments, the apparatus further includes an application program for recommending to the apparatus user specific water amounts and intervals for a given animal or animal breed or species.

Other objects of the invention are achieved by providing a method of providing water to an animal in selected amounts at predetermined intervals without human attendance, comprising the steps of: providing a basin; providing a conduit including at least one valve, the conduit in fluid communication with a water supply and the basin; providing a controller; providing a sensor in communication with the controller; and wherein the controller via the sensor actuates the at least one value to maintain a selected level or amount of water in the basin.

Other objects of the invention are achieved by providing an apparatus for providing water to an animal in selected amounts at predetermined intervals without human attendance, comprising: a basin; a plurality of liners covering the basin; a conduit including at least one valve, the conduit in fluid communication with a water supply and the basin; and a sensor in communication with a controller; wherein the controller via the sensor actuates the at least one value to maintain a selected level or amount of water in the basin, wherein the plurality of liners are removeable.

In certain embodiments, said plurality of liners are made of flexible plastic.

In certain embodiments, said plurality of liners are plastic bags.

In certain embodiments, said plurality of liners include a set of plastic inserts, such that each of the plastic inserts are stored in a kit that fully encompasses the top surface of the basin.

Other objects of the invention and its particular features and advantages will become more apparent from consideration of the following drawings and accompanying detailed description. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1 is a schematic diagram of one embodiment of the inventive system and method; depicting a pressurized supply of water.

FIG. 2 is a schematic diagram of another embodiment of the inventive system and method; depicting distal or remote supply of water.

FIG. 3 is a schematic diagram of another embodiment of the inventive system and method; depicting a proximal supply of water.

FIG. 4 is a schematic diagram of another embodiment of the inventive system and method; depicting another embodiment of a distal or remote supply of water.

FIG. 5 is a schematic diagram of another embodiment of the inventive system and method; depicting a supply of nutritional supplements.

### DETAILED DESCRIPTION OF THE INVENTION

For this application the following terms and definitions shall apply:

The terms “first” and “second” are used to distinguish one element, set, data, object or thing from another, and are not used to designate relative position or arrangement in time.

The terms “coupled”, “coupled to”, and “coupled with” as used herein each mean a relationship between or among two or more devices, apparatus, files, programs, media, components, networks, systems, subsystems, and/or means, constituting any one or more of (a) a connection, whether direct, wirelessly, or through one or more other devices, apparatus, files, programs, media, components, networks, systems, subsystems, or means, (b) a communications relationship, whether direct, wirelessly, or through one or more other devices, apparatus, files, programs, media, components, networks, systems, subsystems, or means, and/or (c) a functional relationship in which the operation of any one or more devices, apparatus, files, programs, media, components, networks, systems, subsystems, or means depends, in whole or in part, on the operation of any one or more others thereof.

The terms “controller”, “processor”, “logic circuit”, or “computer”, as used herein, each mean, for example but not limited to, a unit, component, or device capable of various and differing electrical or electronic output signal functionality based upon differing electrical or electronic inputs signals; may include analog, digital, advanced digital, serial, parallel, multiplexed, encoded, and/or cryptographic signaling, and may or may not utilize configurable data, software, firmware, or a program.

The terms “process” and “processing” as used herein each mean an action or a series of actions including, for example but not limited to, the continuous or non-continuous, synchronous or asynchronous, direction of data, modification, formatting and/or conversion of data, tagging or annotation of data, measurement, comparison and/or review of data, and may or may not comprise a program.

The term “data” as used herein means any indicia, signals, marks, symbols, domains, symbol sets, representations, and any other physical form or forms representing information, whether permanent or temporary, whether visible, audible, acoustic, electric, magnetic, electromagnetic or otherwise manifested. The term “data” as used to represent predetermined information in one physical form shall be deemed to encompass any and all representations of the same predetermined information in a different physical form or forms.

The term “network” as used herein includes both networks and internetworks of all kinds, including the Internet, and is not limited to any particular network or inter-network.

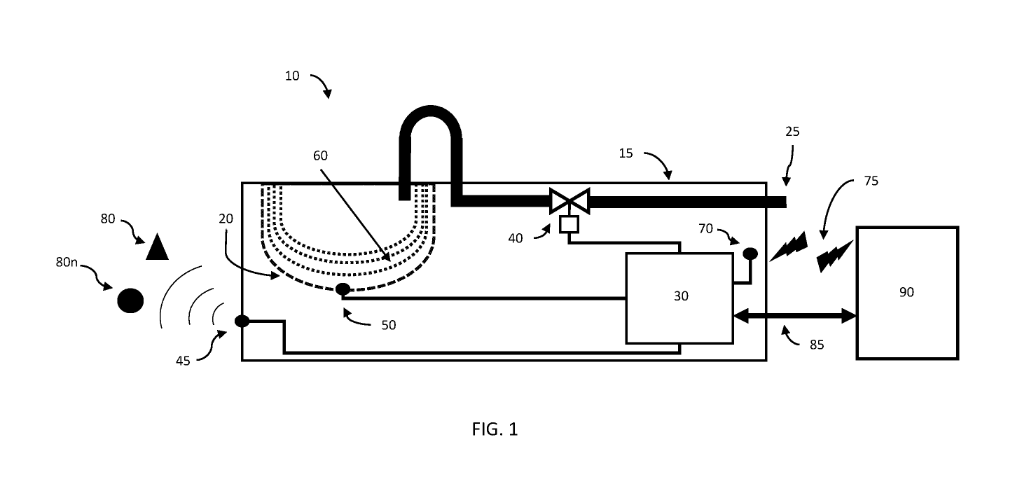

Referencing FIG. 1, in one advantageous and exemplary embodiment of the inventive intelligent water dispensing system 10, a housing 15 is provided including a basin 20 for holding water for consumption. The housing 15 also includes a control valve 40 coupled to a controller 30, the control valve 40 being in fluid communication with a water source 25. Also coupled to the controller 30 is a first basin water sensor 50, and an animal identification sensor 45.

One static or quiescent theory of operation of the present embodiment may be as follows: To prevent water from being continually dispensed into the basin 20 and causing unintentional flooding, it is contemplated that the control valve 40 remains in a disabled or deactivated (i.e. no water can pass therethrough) when electrical power is absent, and/or if electrical power is present and command and control is lost from the controller 30. Water under pressure 25, either by public utility or by a gravity fed water source, is coupled to control valve 40 which is in a powered and “disabled” state (i.e. no water can pass therethrough). First water sensor 50 detects if water is in the basin 20. The first water sensor 50 may be for example a sensor of weight or mass corresponding to a given amount of water in the basin 20, but may be of another type such as but not limited to infrared, light diffraction, eddy current, electrical conductivity/resistance, or temperature.

One dynamic theory of operation of the present embodiment may be as follows: Dependent upon the amount of water present in the basin 20, the first water sensor 50 will indicate or communicate to the controller 30 whether the basin 20 is “empty” or “not-empty”. Animal sensor 45 may be a motion, infrared, camera or other type sensor which can detect if any animal has come near the basin 30. The animal sensor 45 upon detecting an animal will indicate or communicate “animal present” or the like to the controller 30. If the first water sensor 50 indicates “not-empty”, meaning that a known or desired amount of water is currently in the basin 30, then the controller 30 will not enable or activate the control valve 40 and continue to prevent the flow of water therethrough. However, if the first water sensor 50 indicates “empty”, meaning that a known or desired amount of water is absent in the basin 30, then the controller 30 will enable or activate the control valve 40 allowing water to flow therethrough and into the basin 20. When and if the control valve 40 is activated, water may continue to fill the basin 20 until the first water sensor 50 indicates or communicates to the controller 30 “not-empty”, at which time the controller 30 will disable or deactivate the control valve 40 stopping the flow of water to the basin 20.

In the advantageous embodiment above and just described, any and many animals may be detected and provided with water. An additional advantageous embodiment may include a first animal identifier 80, and/or a plurality of animal identifiers. It is contemplated that a particular animal identifier 80 may be programmed or configured to be differentiated from another or a plurality animal identifiers 80n. By affixing or implanting an animal identifier 80 to, on, or in an animal, the controller 13, can then differentiate one animal having an animal identifier 80 from another animal with a differently configured animal identifier 80n; and thereby halt, regulate, or allow water availability as desired for each different animal. Additionally, it is contemplated that the controller 30 is capable if retaining a record of how much water is being provided overall, provided for and to a particular animal, and other useful statistical water use and consumption data.

It is also contemplated that the controller 30 may also be coupled to a wireless interface 70 and/or a wired coupling or connection 85 for communicating with a network such as but not limited to the Internet or other local or wide area intra-network, and/or for communication with smart-phones and other devices via Bluetooth, Wi-Fi, or other “smart-device” remote connectivity 90. This “smart-device” remote connectivity 90 enables application command and control of the system 10, as well as providing system 10 status, water use and consumption data, and the like to a system 10 user.

Additionally, as depicted in FIG. 1, a single or a plurality if nested and replaceable basin liner(s) 60 may be utilized for ease of cleaning and preventing buildup of calcium and other mineral deposits which may be harmful to an animal. It is contemplated that the basin liner(s) 60 may be ridged, semi-ridged, or flexible; and may comprise a plastic, ceramic, synthetic, or other natural materials.

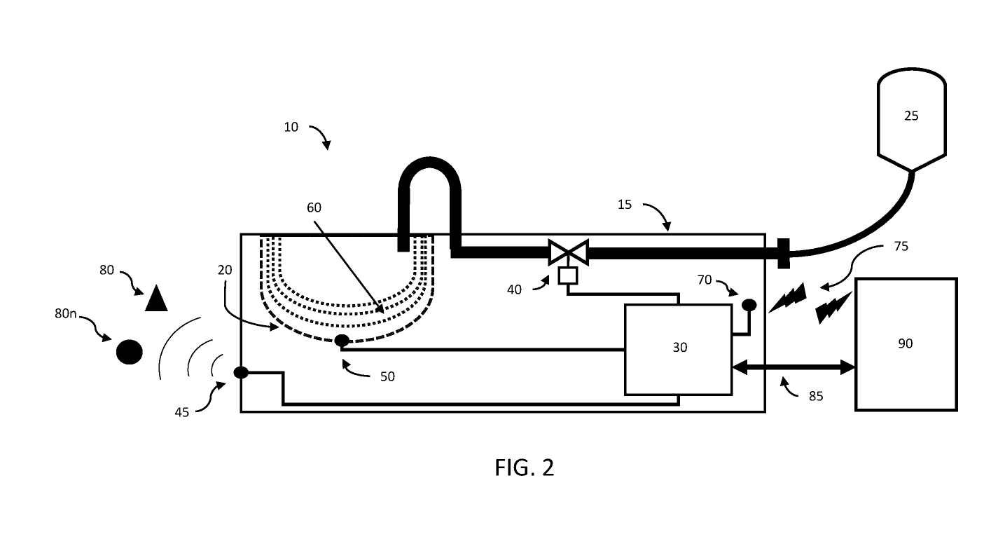

As depicted in FIG. 2, it is contemplated that the water source 25 may be remote or geographically dislocated from the housing 15, and provide gravity and/or internally induced water pressure to control valve 40.

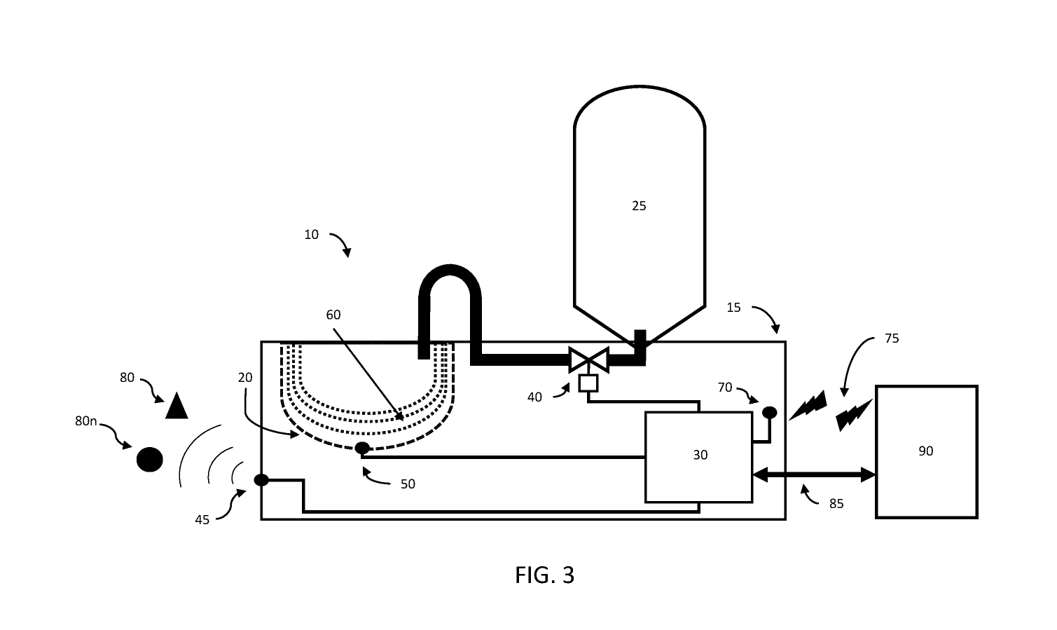

As depicted in FIG. 3, it is contemplated that the water source 25 may be removeably attached or affixed to the housing 15; and provide water to the control valve 40 via gravity and/or internally induced pressure.

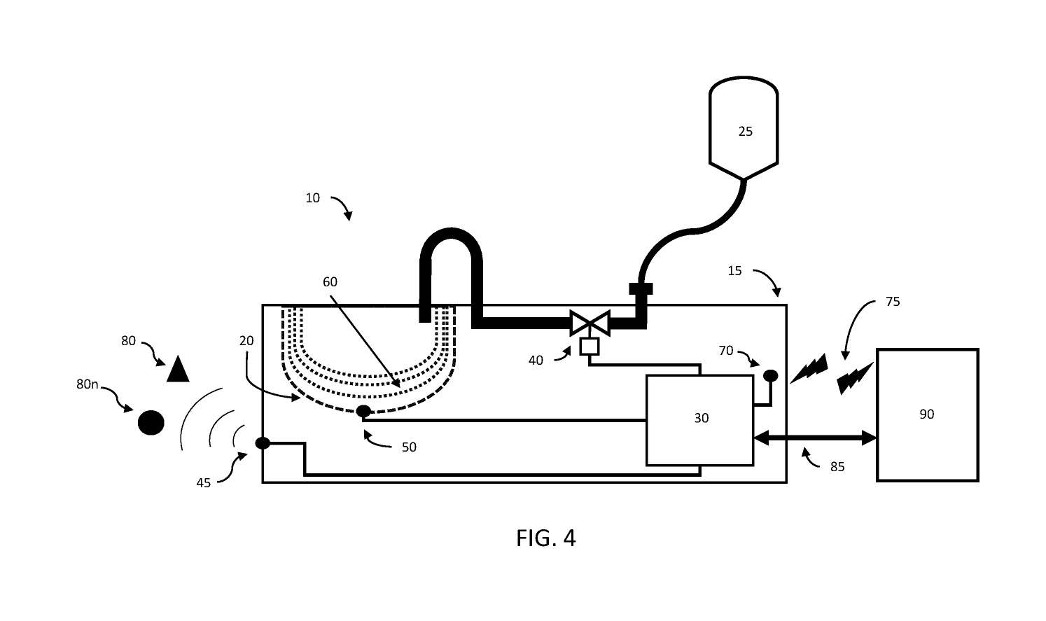

As depicted in FIG. 4, it is contemplated that the water source 25 may be removeably, and remotely via a conduit, attached or affixed to the housing 15; and provide water to the control valve 40 via gravity and/or internally induced pressure.

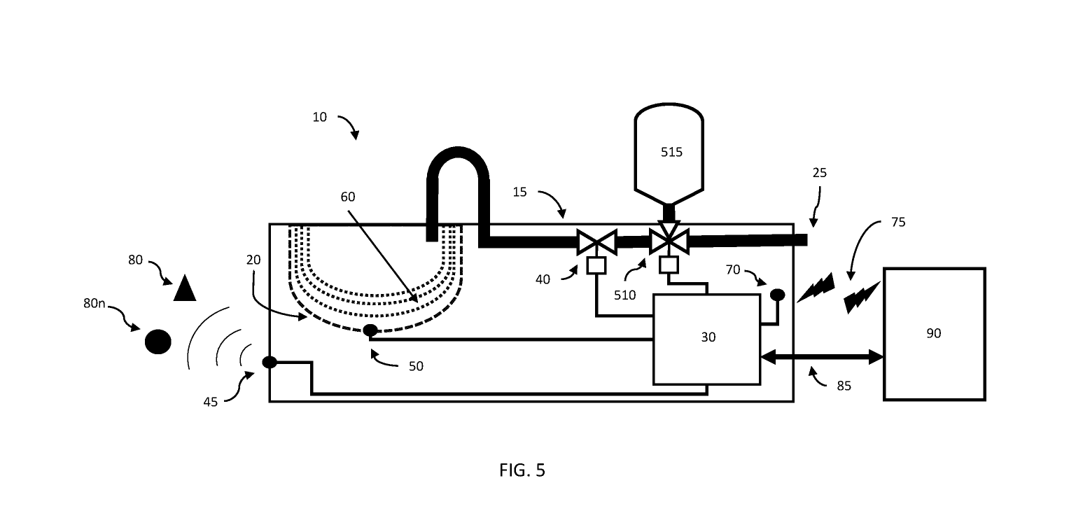

As depicted in FIG. 5, it is contemplated that the system may include a supply of nutritional supplements 510 may be included and in fluid communication with primary water supply conduit via a nutrient supplement control valve 515 coupled to the controller 13. Depended upon the nutritional requirements of an individual animal, a sub-group, or a group of animals, the system via an application program may dispense the supplement as per system user instructions. It is contemplated that the activation and deactivation of the nutritional supplement control value 515 is very similar to that of the water control valve 40. It is also contemplated that the supply of nutritional supplements 510 may be directly or remotely coupled to the housing as may be the supply of water 25; as detailed above and depicted in FIG. 1 through FIG. 4.

It is also contemplated that the system 10 may include one or more filters (not shown), for removing contaminates and particulates from the supply of water 25, and/or the supply of nutritional supplements. The filters may be configured at various locations in the water and supplement flow paths, and it is contemplated that the filters are integral to the control valves (40, 515) and/or may be insertable and removable from the water and supplement paths for cleaning and required replacement. It is further contemplated that a single filter is used in both the water and supplement fluid paths.

In certain embodiments of the invention, liners are provided in the bowl so that a user does not have to wash the bowl. In such embodiments, this advantageous for kennels as a user has to change the water in bowls for the animals every few hours and the liners save the pets from contamination.

In certain embodiments, the system is connected to a mobile application or computer software program that records how much water a pet is consuming.

In certain embodiments, the system includes two or more basins for two or more pets.

In certain embodiments, the basis are of different sizes.

In certain embodiments, the system includes controlled water flow so as to record how much water a pet is consuming.

In certain embodiments, the system and mobile application involves providing services to pet owners, such that data is tracked and so that a pet owner is able to record and know data and statistic regarding their pet.

In certain embodiments, the data collected by the system and mobile application or computer software program may be exploited for medical, scientific, and industrial purposes.

In certain embodiments, the system includes a processor, server, and/or other computer hardware that allows for the system to be connected to the Internet and/or allows the system and/or website and/or server to track information about one or more pets.

In certain embodiments, the system includes a collar around the pet and the collar is connected to the system by RFID technology and/or Bluetooth.

While the invention has been specifically described in connection with certain specific embodiments thereof, it is to be understood that this is by way of illustration and not of limitation and that various changes and modifications in form and details may be made thereto, and the scope of the appended claims should be construed as broadly as the prior art will permit.

The description of the invention is merely exemplary in nature, and thus, variations that do not depart from the gist of the invention are intended to be within the scope of the invention. Such variations are not to be regarded as a departure from the spirit and scope of the invention.

What is claimed is:

1. A system for providing water to an animal in selected amounts at predetermined intervals without human attendance, comprising:
a housing including a basin;
a conduit including at least one valve, the conduit in fluid communication with the water supply and the basin;
a sensor in communication with a controller; and
wherein the controller via the sensor actuates the at least one value to maintain a selected level or amount of water in the basin.

2. The system of claim 1, wherein the controller is capable of interfacing with a wired or wireless communication network.

3. The system of claim 2, wherein the communication network is connected to and interfaces with the internet.

4. The system of claim 1, wherein the supply of water is self-contained and provided to the basin via the conduit and at least one valve by gravity.

5. The system of claim 1, wherein the supply of water is under pressure at the input of the at least one valve.

6. The system of claim 1, wherein the conduit or at least one valve includes a filter.

7. The system of claim 1, wherein the water supply includes a nutritional supplement.

8. The system of claim 7, wherein the controller via the at least one value regulates the amount of the nutritional supplement included in the water supply.

9. The system of claim 8, further including a nutritional supplement supply, the nutritional supplement supply in fluid communication with the water supply via a second conduit and second valve; whereby the controller via the second valve regulates the amount of the nutritional supplement added to the water supply.

10. The system of claim 9, wherein the controller via communication with the internet provides water and/or nutritional supplement supply use information and parameters to a system user.

11. The system of claim 3, further including an application program for remotely selecting amount and intervals of water and/or nutritional supplements supplied to the animal.

12. The system of claim 10, further including an application program for recommending to the system user specific water and/or nutritional supplement amounts and intervals for a given animal, or animal breed or species.

13. The system if claim 1, further including a single or a plurality of liners, the liners being ridged, semi-ridged, or flexible; and comprises a plastic, ceramic, synthetic, or other natural material.

14. A method of providing water to an animal in selected amounts at predetermined intervals without human attendance, comprising the steps of:
providing a basin;
providing a conduit including at least one valve, the conduit in fluid communication with the water supply and the basin;
providing a controller;
providing a sensor in communication with the controller; and
wherein the controller via the sensor actuates the at least one value to maintain a selected level or amount of water in the basin.

15. The system if claim 1, further including a single or a plurality of liners, the liners being ridged, semi-ridged, or flexible; and comprises a plastic, ceramic, synthetic, or other natural material.

16. An apparatus for providing water to an animal in selected amounts at predetermined intervals without human attendance, comprising:
a basin;
a plurality of liners covering the basin;
a conduit including at least one valve, the conduit in fluid communication with a water supply and the basin; and
a sensor in communication with a controller;
wherein the controller via the sensor actuates the at least one value to maintain a selected level or amount of water in the basin,
wherein the plurality of liners are removeable.

17. The apparatus of claim 16, wherein said plurality of liners are made of flexible plastic.

18. The apparatus of claim 16, wherein said plurality of liners are plastic bags.

19. The apparatus of claim 16, wherein said plurality of liners include a set of plastic inserts, such that each of the plastic inserts are stored in a kit that fully encompasses the top surface of the basin.
